(19) United States
(12) Patent Application Publication
(10) Pub. No.: US 2024/0240700 A1
(43) Pub. Date: Jul. 18, 2024

(54) SHAFT, HUB, SHAFT-HUB CONNECTION, AND ELECTRIC ACTUATOR

(71) Applicant: IMS GEAR SE & CO. KGAA, Donaueschingen (DE)

(72) Inventors: Marius SUESS, Blumberg (DE); Stefan WILLMANN, Huefingen (DE); Michael KNOEPFLE, Huefingen (DE); Sebastian BIRK, Trossingen (DE); Paul SCHACHTSCHNEIDER, Villingen-Schwenningen (DE)

(21) Appl. No.: 18/412,886

(22) Filed: Jan. 15, 2024

(30) Foreign Application Priority Data
Jan. 16, 2023 (EP) 23151781.4

(51) Int. Cl. F16H 25/24

(52) U.S. Cl. CPC F16H 25/24

(57) ABSTRACT

A shaft, for transmitting a torque and/or an axial force, has a longitudinal shaft axis, a shaft lateral surface, and a shaft end. The shaft lateral surface has at least one recess with an axial recess wall and a radial recess wall adjacent to the axial recess wall. The at least one recess is open axially in the direction of the shaft end. The radial recess wall has a recess radius, such that the radial recess wall has, at least in portions, a concave recess arc shape facing away from the longitudinal shaft axis. A hub has a longitudinal hub axis and at least one hub arcuate portion has a convex hub arc shape facing the longitudinal hub axis. A shaft-hub connection has a shaft and a hub, and an electric actuator has a shaft-hub connection.

The invention relates to a shaft for transmitting a torque and/or an axial force, to a hub, to a shaft-hub connection, and to an electric actuator.

A large number of shaft-hub connections for a wide variety of applications are known in the prior art. In the field of electric actuators, such as electric brake boosters, it is known in particular to connect a shaft designed as a spindle at one end to a hub designed as a plate in order to fix the spindle with respect to a machine element that moves relative to the spindle. The connection of the spindle to the plate must therefore be able to transmit torques acting around the longitudinal axis of the spindle as well as axial forces acting along the longitudinal axis of the spindle. Sometimes there is a requirement that corresponding shaft-hub connections may only take up a limited amount of installation space.

Such connections have hitherto been realized by means of a weld seam connecting the spindle to the plate. However, such a connection requires that the materials of both parts are weldable. Corresponding materials or surfaces have disadvantages with regard to corrosion resistance, however. In addition, the components must be freed from oil residues before the weld is applied, as oil residues generally have a negative effect on the properties of the weld.

The object of the invention is therefore that of providing a reliable and robust connection between a shaft and a hub, which requires little installation space and can be produced inexpensively. A further object of the invention is that of providing a shaft and a hub for such a connection. Yet a further object of the invention is that of providing a high-quality electric actuator that requires little installation space and can be produced inexpensively.

The object is achieved according to the invention by a shaft having the features of claim 1, a hub having the features of claim 10, a shaft-hub connection having the features of claim 15, and an electric actuator having the features of claim 19.

Advantageous embodiments and developments of the invention are specified in the dependent claims.

A shaft according to the invention for transmitting a torque and/or an axial force comprises a longitudinal shaft axis, a shaft lateral surface and a shaft end. The shaft lateral surface has at least one recess with an axial recess wall and a radial recess wall adjacent to the axial recess wall. The axial recess wall can be particularly suitable for transmitting axial forces. The radial recess wall can be particularly suitable for transmitting torques acting around the longitudinal shaft axis. The radial recess wall is preferably located parallel to the longitudinal shaft axis. The axial recess wall in turn is preferably located at a right angle to the radial recess wall. The radial recess wall preferably adjoins the axial recess wall in such a way that a shaft-side transition radius is provided at the transition from the radial recess wall to the axial recess wall and can serve in particular to reduce notch stresses.

The radial recess wall has a first wall end and a second wall end. Each of the wall ends is preferably formed by an intersection line of the radial recess wall with the shaft lateral surface.

The at least one recess is open axially in the direction of the shaft end. A corresponding axial opening is therefore preferably located opposite the axial recess wall. Thus, coming axially from the direction of the shaft end, the shaft preferably does not have a shaft portion that would at least partially cover the at least one recess. Preferably, a hub with an element engaging the at least one recess can be pushed onto the shaft from the end of the shaft until the engaging element comes to rest on the axial recess wall.

Unless otherwise stated, the terms “axial” and “radial” preferably refer here and in the following to the longitudinal shaft axis and/or the longitudinal hub axis.

According to the invention, the radial recess wall has a recess radius, such that the radial recess wall has, at least in portions, a concave recess arc shape facing away from the longitudinal shaft axis. As a result, the radial recess wall can be particularly advantageously suitable for transmitting torques acting around the longitudinal shaft axis. Due to the concave recess arc shape facing away from the longitudinal shaft axis, the at least one recess is preferably trough-shaped when viewed from the shaft lateral surface. In particular, the radial recess wall can deviate from an imaginary straight line connecting the first wall end to the second wall end due to the concave recess arc shape between the first wall end and the second wall end. The design according to the invention, of the radial recess wall, is preferably not inconsistent with shaping in such a way that the radial recess wall is straight in portions. For example, the radial recess wall can comprise a plurality of straight lines that have an angular offset from one another and can be connected to one another by means of an arcuate portion. The angular offset can be in the range between 900 and 180°.

In a preferred embodiment of the invention, the recess arc shape of the radial recess wall extends from the first wall end to the second wall end and/or the recess radius is variable. If the recess arc shape of the radial recess wall extends from the first wall end to the second wall end, the entire radial recess wall is preferably arcuate, so that the radial recess wall is free of a straight portion in the direction from the first wall end to the second wall end. If the recess radius is variable, the recess radius is preferably not constant. The radial recess wall is therefore preferably not constantly curved. Due to the variable design of the recess radius, the transmission of torque via the radial recess wall can be made more uniform and thus the stress, in particular on the contact surfaces involved, can be reduced. The recess radius is particularly preferably larger than an outer radius of the shaft.

Particularly preferably, the recess arc shape of the radial recess wall corresponds to at least one portion of a hypotrochoid. This is preferably a contour which can be produced quickly and easily and can enable uniform torque transmission. Here and in the following, a hypotrochoid is preferably understood to mean a path that a point situated on a circle describes when said circle rolls within another circle, known as the base circle. The point under consideration can lie outside or inside the rolling circle.

In parametric representation, the hypotrochoid can be described with the following set of formulas:

xθ=R−r cos(θ)+d cos R−rrθ

yθ=R−r sin(θ)−d sin R−rrθ

Here R is the radius of the base circle, r is the radius of the rolling circle, and d is the distance of the point from the center of the rolling circle. The parameter d can therefore be viewed as a measure of the eccentricity. The ratio R/r is preferably chosen so that it results in a natural number. In this case in particular, the ratio can indicate the number of “corners” of the hypotrochoid. In the present case, the ratio R/r is preferably at least 3. The ratio R/r=4 is particularly preferred.

A hypotrochoid center of the hypotrochoid is preferably located on the longitudinal shaft axis. The ratio R/r therefore preferably corresponds to the number of recesses. The recesses can therefore be distributed evenly and symmetrically around the circumference of the shaft. The shaft can be designed such that the corners of the hypotrochoid are located outside the shaft. In a corresponding embodiment of the invention, the corners are therefore not depicted directly in the recess arc shape.

In a development of the invention, the shaft lateral surface has a spindle toothing with at least one spindle tooth. Preferably, the at least one spindle tooth rotates helically around the shaft along the longitudinal shaft axis. The shaft can thus function as a spindle, for example of a spindle drive.

The axial recess wall of at least one of the at least one recess can be formed at least in portions by a cut surface of the at least one spindle tooth. In this way, the at least one spindle tooth can end in the axial recess wall. In this way, a particularly favorable transmission of an axial force can take place between the shaft and an element arranged in the at least one recess.

The cut surface of the at least one spindle tooth is preferably located at a distance from the first wall end and/or the second wall end of the radial recess wall. The wall ends are preferably formed at the points at which the radial recess wall emerges from the shaft along the recess arc shape. The location of the cut surface preferably depends in particular on the torque transmitted by the shaft. Along the radial recess wall, the torque transmission usually takes place predominantly in the region of at least one of the wall ends. Particularly depending on the direction of rotation, the torque transmission can take place mainly in the region of the first wall end or the second wall end.

As described above, axial forces from or to the shaft are usually transmitted largely via the cut surface of the at least one spindle tooth. By locating the cut surface of the at least one spindle tooth with respect to the first wall end and/or the second wall end, the mechanical stress on the shaft can thus be distributed as evenly as possible in the region of the recess. In particular, three applications are known from practice to which the shaft can be adapted by locating the cut surface of the at least one spindle tooth relative to the wall ends.

In a first application, the torque transmission, in particular when the shaft rotates, can substantially only take place in a first direction of rotation and thus mainly in the region of the first wall end. In this case, it is preferable to use an embodiment of the shaft in which the cut surface of the at least one spindle tooth is located at a distance from the first wall end and in the region of the second wall end.

In a second application, the torque transmission, in particular when the shaft rotates, can substantially only take place in a second direction of rotation and thus mainly in the region of the second wall end. In this case, it is preferable to use an embodiment of the shaft in which the cut surface of the at least one spindle tooth is located at a distance from the second wall end and in the region of the first wall end.

In a third application, the torque transmission, in particular when the shaft rotates, can take place in both directions of rotation and thus mainly in the region of the first wall end and the second wall end. In this case, it is preferable to use an embodiment of the shaft in which the cut surface of the at least one spindle tooth is located at a distance from the first wall end and from the second wall end. In this case, the cut surface of the at least one spindle tooth is preferably located centrally between the first wall end and the second wall end.

In a preferred embodiment of the invention, the at least one recess comprises a plurality of recesses and the at least one spindle tooth comprises a plurality of spindle teeth, the number of recesses corresponding to the number of spindle teeth, and the axial recess wall of each of the recesses being formed at least in portions by the cut surface of one of the spindle teeth. This allows the transmission of torques and/or axial forces to be evenly distributed over the circumference of the shaft. Particularly preferably, the shaft has four spindle teeth and four recesses, which are preferably evenly distributed over the circumference of the shaft.

A rim is preferably provided between the axial recess wall and the shaft end. After arranging an element in the at least one recess, the rim can be reshaped and thus secure the element in the axial direction. Preferably, the rim is annular, in particular circular. The rim is preferably free of interruptions along its circumference. The shaft particularly preferably has a central bore along the longitudinal shaft axis. The rim can therefore be formed by an additional shoulder in the shaft lateral surface. Particularly preferably, an outside diameter of the rim is smaller than a maximum outside diameter of the shaft. This means that the shaft can be made easily and inexpensively from bar material. The shaft end is preferably formed by a free end face of the rim. The rim can be cut by the at least one recess.

A hub according to the invention comprises a longitudinal hub axis, a hub opening extending along the longitudinal hub axis, and an inner wall radially delimiting the hub opening. The inner wall has at least one hub arcuate portion with a hub arc radius, such that the at least one hub arcuate portion has a convex hub arc shape facing the longitudinal hub axis. This allows a particularly uniform torque transmission to an element arranged in the hub opening. Due to the convex hub arc shape facing the longitudinal hub axis, the at least one hub arcuate portion is preferably bulbous when viewed from the longitudinal hub axis. The hub opening is preferably completely enclosed in a plane orthogonal to the longitudinal hub axis. The hub is preferably planar.

The hub arc radius is particularly preferably constant. This means that the hub arc radius can be produced particularly easily, in particular in a stamping method. Alternatively, the hub arc radius can be variable. In particular, the hub arc shape of the at least one hub arcuate portion can correspond to at least one portion of a hypotrochoid. The hub arc shape can correspond in particular to the recess arc shape of the hub described above. This makes it particularly easy to arrange the hub on the shaft. Furthermore, for example, the hub arc shape can comprise a plurality of straight lines that have an angular offset from one another and can be connected to one another by means of an arcuate portion. The angular offset can be in the range between 900 and 1800.

The at least one hub arcuate portion preferably has a first hub arc end and a second hub arc end, each of the hub arc ends adjoining an undercut. As a result, a defined contact of the at least one hub arcuate portion on an element arranged in the hub opening can be achieved. The undercuts can each be formed by an undercut hole. The undercut bores are preferably enclosed by the hub opening and can each be oriented concavely toward the longitudinal hub axis. An undercut radius of each of the undercuts is preferably significantly smaller than the hub arc radius.

The at least one hub arcuate portion can have, at the first hub arc end, a tangentially continuous transition to the undercut adjoining the first hub arc end and/or have, at the second hub arc end, a tangentially continuous transition to the undercut adjoining the second hub arc end. By means of the tangentially continuous transition, a particularly large contact surface on an element arranged in the hub bore can be achieved. The tangentially continuous transition is preferably designed in such a way that, at the transition of each hub arc end to the adjacent undercut, the tangents applied to the hub arcuate portion and to the undercut have the same gradient. In other words, the contour of the hub opening is preferably continuously differentiable at the transition from the at least one hub arcuate portion to the corresponding undercut.

When transmitting a torque acting around the longitudinal hub axis to or from an element arranged in the hub opening, the highest loads can occur in the region of the first hub arc end or the second hub arc end, so that the torque transmission takes place mainly in these regions. The tangentially continuous transition allows the load to be distributed over a relatively large area, so that the stress on the hub can be kept low. By selecting which of the hub arc ends has a tangentially continuous transition to the correspondingly adjacent undercut, the hub can be adapted to different applications. In accordance with the applications described above in relation to the shaft, in relation to the hub three applications are substantially known to which the shaft can be adapted by locating the cut surface of the at least one spindle tooth relative to the wall ends.

In a first application, the torque transmission can substantially only take place in a first direction of rotation and thus mainly in the region of the first hub arc end. In this case, it is preferable to use an embodiment of the hub in which the first hub arc end has a tangentially continuous transition to the undercut adjoining the first hub arc end.

In a second application, the torque transmission can substantially only take place in a second direction of rotation and thus mainly in the region of the second hub arc end. In this case, it is preferable to use an embodiment of the hub in which the second hub arc end has a tangentially continuous transition to the undercut adjoining the second hub arc end.

In a third application, the torque transmission can take place in both directions of rotation and thus mainly in the region of the first hub arc end and the second hub arc end. In this case it is possible to use an embodiment in which the first hub arc end has a tangentially continuous transition to the undercut adjoining the first hub arc end and in which the second hub arc end has a tangentially continuous transition to the undercut adjoining the second hub arc end.

Alternatively, the undercut radius can be chosen to be smaller and/or the undercuts can be located further away from the longitudinal hub axis in order to extend the at least one hub arcuate portion in the direction of the first hub arc end and in the direction of the second hub arc end and thus achieve a more uniform load on the distribution.

Preferably, the at least one hub arcuate portion comprises a plurality of hub arcuate portions which are located uniformly in a peripheral direction of the hub opening around the longitudinal hub axis. This allows the load on the hub, particularly when transmitting torque, to be evenly distributed around the longitudinal hub axis. The hub arcuate portions are preferably designed in the same way. If there are three or more hub arcuate portions, the hub opening can thus have the shape of a polygon with undercuts at each of the corners. The hub particularly preferably has four hub arcuate portions.

A shaft-hub connection according to the invention comprises a shaft as previously described and a hub as previously described. The hub is arranged on the shaft in such a way that
the at least one hub arcuate portion is arranged in the at least one recess,
the inner wall of the hub opening is located in the region of the at least one hub arcuate portion so as to face the radial recess wall of the at least one recess, and
a first side surface of the hub is in operative connection with the axial recess wall in the at least one recess.
   The at least one hub arcuate portion can thus form an element arranged in the at least one recess. The shaft can also form an element arranged in the hub opening.

Preferably, the hub is arranged on the shaft in such a way that the longitudinal hub axis is aligned along the longitudinal shaft axis and is located on the longitudinal shaft axis. An operative connection can exist between the inner wall of the hub opening and the radial recess wall, in particular in such a way that the inner wall and the radial recess wall abut one another at least in portions. This allows a force or torque to be transmitted between the inner wall and the radial recess wall.

The operative connection of the first side surface of the hub to the axial recess wall of the at least one recess serves to axially secure the hub on the shaft. This operative connection is preferably designed in such a way that the first side surface directly abuts the axial recess wall.

In addition to the first side surface, the hub preferably has a second side surface, particularly preferably opposite the first side surface. The side surfaces can each be formed by surfaces of the hub that adjoin the inner wall at an end face. Due to being situated at an end face, the first side surface and the second side surface are preferably oriented substantially orthogonally to the longitudinal hub axis. The edge between the inner wall and the first side surface can have a hub-side transition radius, which preferably corresponds to the shaft-side transition radius. This makes it easier to mount the hub on the shaft.

The at least one hub arcuate portion preferably corresponds in number and arrangement to the at least one recess. Preferably, the hub thus has the same number of hub arcuate portions as the shaft has recesses. Due to the arrangement of the hub arcuate portions corresponding to the location of the recesses, exactly one hub arcuate portion can be arranged in each of the recesses. The shaft particularly preferably has four recesses and the hub has four hub arcuate portions.

In a preferred embodiment of the shaft-hub connection, the shaft has, in the region of the first hub arc end and in the region of the second hub arc end of the at least one recess, an oversize relative to the hub, and the shaft has backlash in a central region of the at least one hub arcuate portion, between the first hub arc end and the second hub arc end. This allows a zero-backlash connection between the hubs and the shaft to be achieved, especially at the points where a significant portion of the torque transmission takes place, and at the same time the required assembly force can be kept low.

In an alternative embodiment, the shaft-hub connection can be designed in such a way that the shaft has, in the region of the first hub arc end and in the region of the second hub arc end of the at least one recess, backlash relative to the hub, and that the shaft has, in a central region of the at least one hub arcuate portion, between the first hub arc end and the second hub arc end, an oversize relative to the hub.

Preferably, the shaft-hub connection is designed in such a way that the rim of the shaft is reshaped, preferably flanged, radially outwards and axially in the direction of the hub, and the second side surface of the hub, located opposite the first side surface, is in operative connection with the reshaped rim. This allows the hub to be secured to the shaft in both axial directions. The operative connection between the second side surface and the reshaped rim is preferably designed in such a way that the reshaped rim abuts, particularly preferably directly, the second side surface.

A method for producing a shaft-hub connection having a reshaped rim can comprise the following steps:
providing a shaft as previously described having the rim as previously described,
providing a hub as previously described,
arranging the hub on the shaft in such a way that
   the at least one hub arcuate portion is arranged in the at least one recess,
   the inner wall of the hub opening is located in the region of the at least one hub arcuate portion so as to face the radial recess wall of the at least one recess, and
   a first side surface of the hub is in operative connection with the axial recess wall in the at least one recess,
reshaping the rim, which projects axially beyond the hub, radially outward and axially in the direction of the hub, in particular by flanging, in particular by a tumbling method or a roller burnishing method,
terminating the reshaping process as soon as the rim comes into contact with the second side surface.

By reshaping the rim, which projects axially beyond the hub, radially outward and axially in the direction of the hub, the air-filled space located between the inner wall of the hub and the shaft can be at least partially filled with the material of the shaft. This can improve the connection between the shaft and the hub. By using a tumbling process or a roller burnishing method, the reshaping process can be realized with a short production time. Preferably, the reshaping is terminated immediately after the rim has come into contact with the second side surface, since if the reshaping process continues, the strength of the reshaped rim can decrease.

An electric actuator according to the invention comprises a shaft-hub connection as previously described. The electric actuator can be designed, for example, as an electric brake booster, in particular for a vehicle. Such brake boosters are used in particular in electrically powered vehicles, such as electric cars.

An exemplary embodiment of the invention is explained using the following figures, in which:

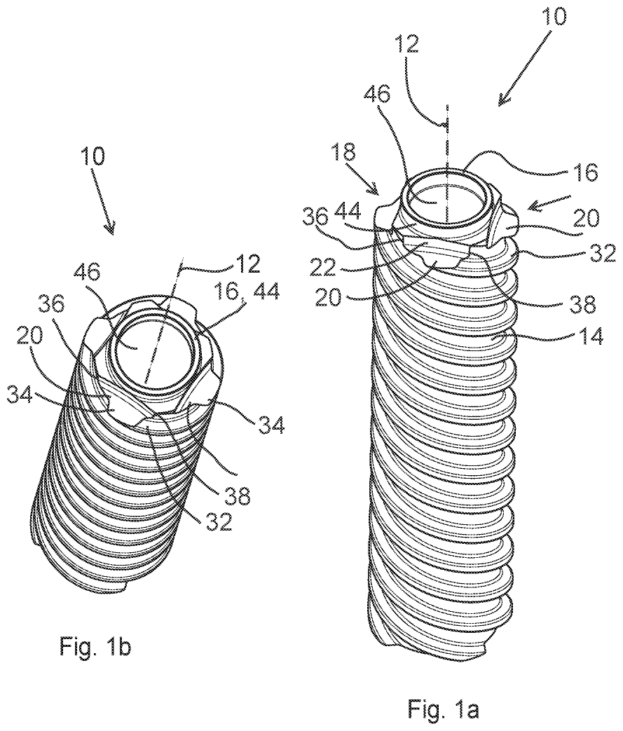

FIG. 1a shows a first perspective representation of a first exemplary embodiment of a shaft;

FIG. 1b shows a second perspective representation of the exemplary embodiment shown in FIG. 1;

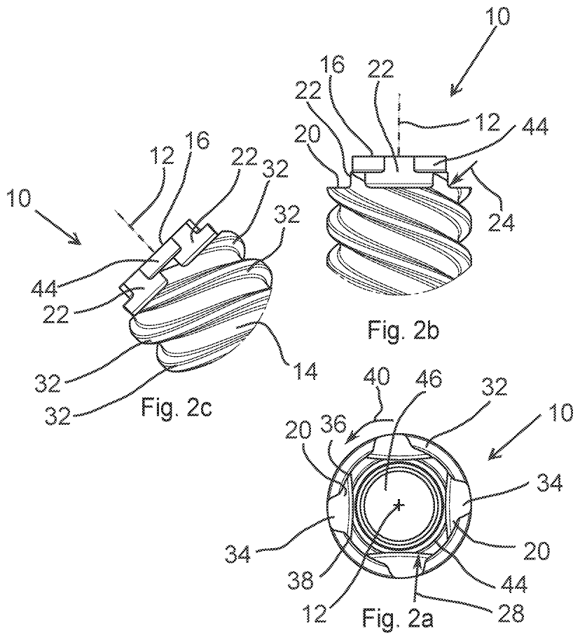

FIG. 2a is a top view of a second exemplary embodiment of a shaft;

FIG. 2b is a first side view of the exemplary embodiment shown in FIG. 2a;

FIG. 2c is a second side view of the exemplary embodiment shown in FIG. 2a;

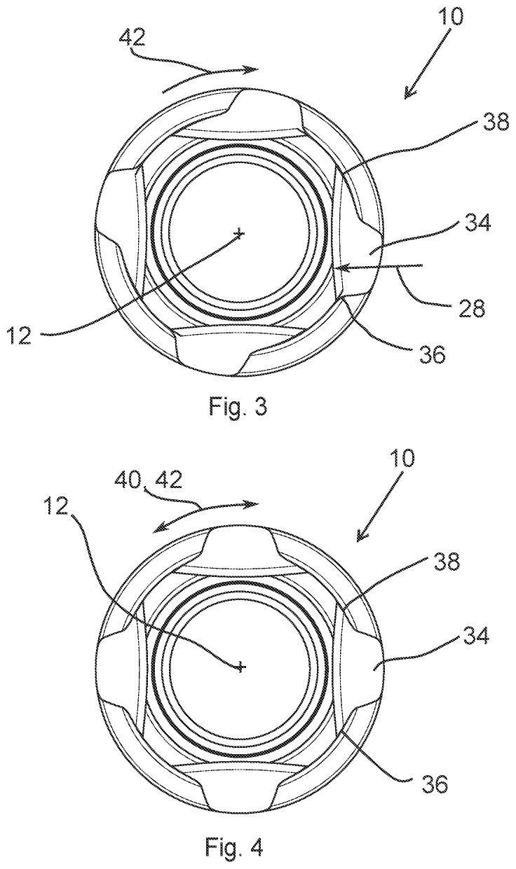

FIG. 3 is a top view of a third exemplary embodiment of a shaft;

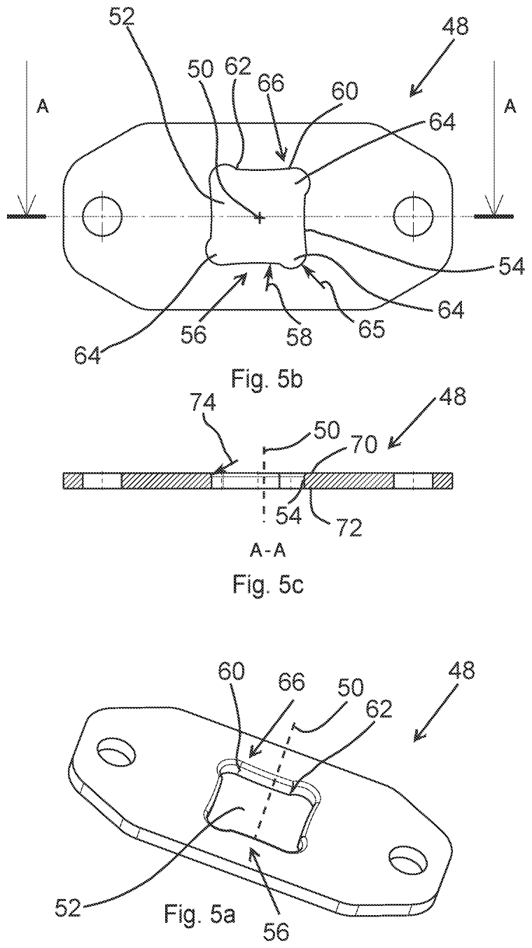

FIG. 4 is a top view of a fourth exemplary embodiment of a shaft;

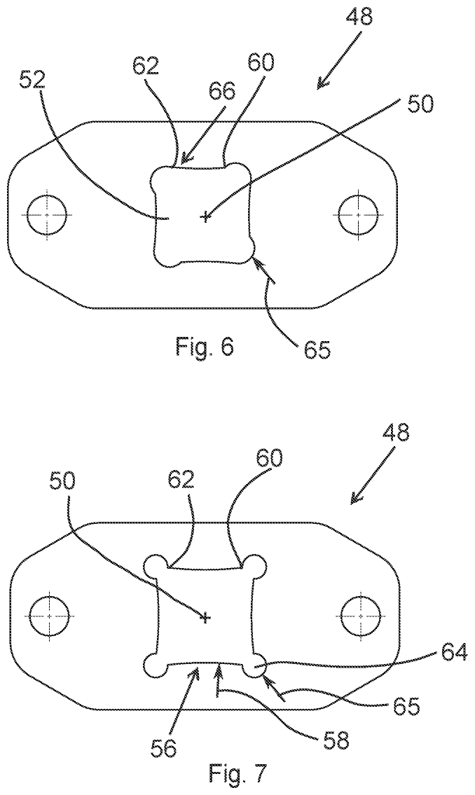

FIG. 5a is a perspective representation of a first exemplary embodiment of a hub;

FIG. 5b is a top view of the exemplary embodiment shown in FIG. 5a with section plane A-A shown;

FIG. 5c is the sectional view A-A shown in FIG. 5b of the exemplary embodiment shown in FIG. 5a;

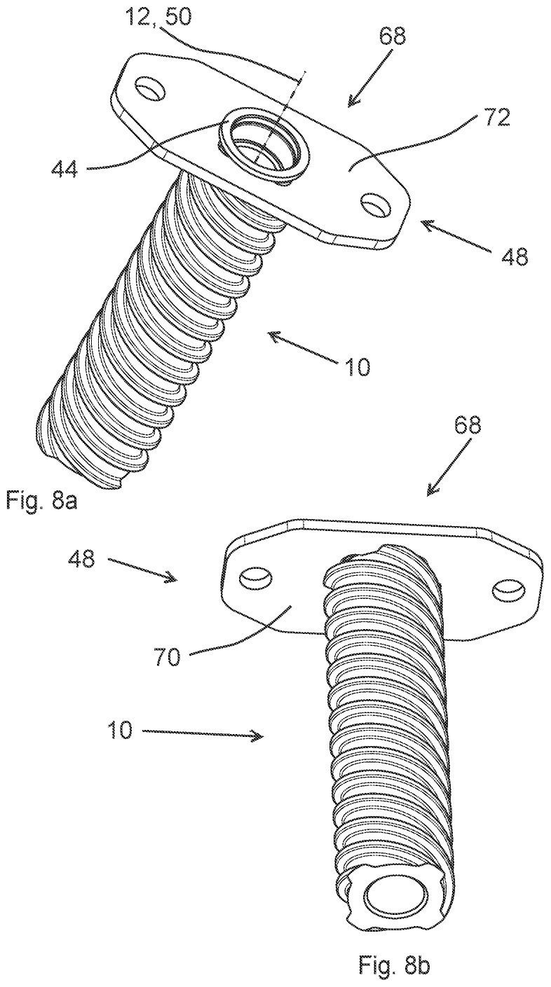

FIG. 6 is a top view of a second exemplary embodiment of a hub;

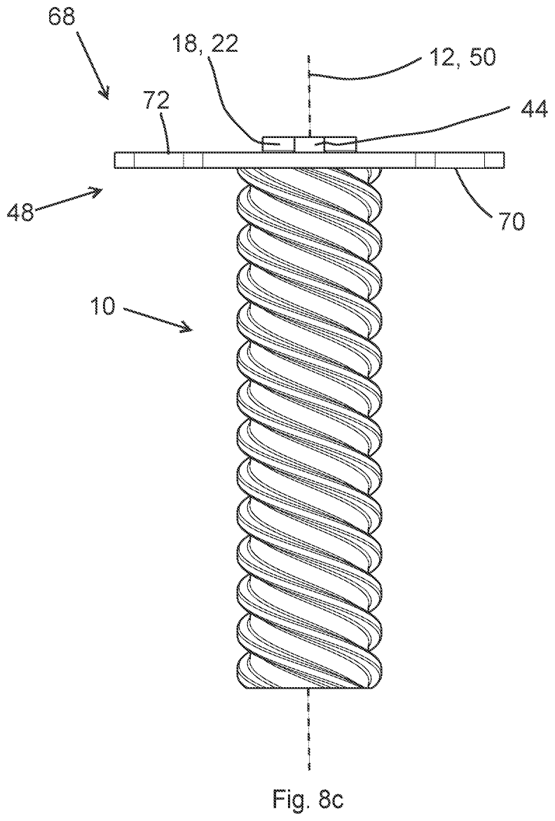

FIG. 7 is a top view of a third exemplary embodiment of a hub;

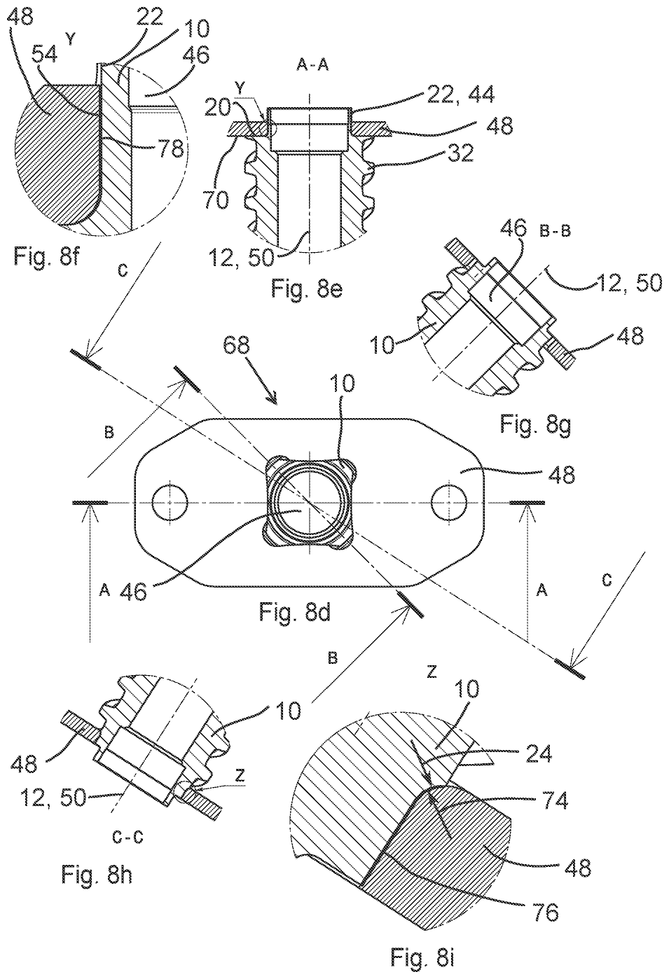

FIG. 8a shows a first perspective representation of an exemplary embodiment of a shaft-hub connection;

FIG. 8b shows a second perspective representation of the exemplary embodiment shown in FIG. 8a;

FIG. 8c is a side view of the exemplary embodiment shown in FIG. 8a;

FIG. 8d is a top view of the exemplary embodiment shown in FIG. 8a with section planes A-A, B-B, and C-C shown;

FIG. 8e shows a detail of the sectional view A-A shown in FIG. 8d of the exemplary embodiment shown in FIG. 8a with marked detail Y;

FIG. 8f is an enlarged representation of the detail Y shown in FIG. 8e;

FIG. 8g shows a detail of the sectional view B-B shown in FIG. 8d of the exemplary embodiment shown in FIG. 8a;

FIG. 8h shows a detail of the sectional view C-C shown in FIG. 8d of the exemplary embodiment shown in FIG. 8a with marked detail Z; and

FIG. 8i is an enlarged representation of the detail Z shown in FIG. 8h.

FIG. 1a to 8i show different views of different exemplary embodiments. The same reference numbers are used for identical and functionally identical parts. For the sake of clarity, not all reference signs are used in every figure.

FIGS. 1a and 1b show a first exemplary embodiment of a shaft 10 for transmitting a torque and/or an axial force. The shaft 10 comprises a longitudinal shaft axis 12, a shaft lateral surface 14 and a shaft end 16. The shaft lateral surface 14 has four recesses 18. Each of the recesses 18 has an axial recess wall 20 and a radial recess wall 22 adjacent to the axial recess wall 20, each radial recess wall 22 having a first wall end 36 and a second wall end 38. While the axial recess wall 20 is particularly suitable for transmitting axial forces, the radial recess wall 22 is provided in particular for transmitting torques acting around the longitudinal shaft axis 12.

Each of the radial recess walls 22 is located parallel to the longitudinal shaft axis 12. The axial recess walls 20 are in turn located at a right angle to the corresponding radial recess wall 22. The radial recess walls 22 preferably adjoin the corresponding axial recess walls 20 in such a way that a shaft-side transition radius 24 is arranged at the transition from each of the radial recess walls 22 to the corresponding axial recess wall 20 and can serve in particular to reduce notch stresses.

Each of the recesses 18 is open axially in the direction of the shaft end 16. Coming axially from the direction of the shaft end 16, the shaft 10 does not have a shaft portion that would even partially cover the recesses 18 (see in particular FIG. 1b). Preferably, a hub 48 shown in FIG. 5a to 7 can thus be pushed onto the shaft 10 from the shaft end 16 until the hub 48 comes to rest against the axial recess wall 20.

Each of the radial recess walls 22 has a recess radius 28, such that each of the radial recess walls 22 has a concave recess arc shape facing away from the longitudinal shaft axis 12. Due to the concave recess arc shape facing away from the longitudinal shaft axis 12, the recesses 18 are preferably trough-shaped when viewed from the shaft lateral surface 14.

Each recess radius 28 is variable such that the recess arc shape of the radial recess wall 22 extends from the first wall end 36 to the second wall end 38 and/or the recess radius 28 is variable. The recess radius 28 is variable in such a way that the recess arc shape of each of the radial recess walls 22 corresponds to a portion of a hypotrochoid. The recess arc shapes of all recesses 18 in the shaft 10 correspond to portions of a single imaginary hypotrochoid. This applies to each of the exemplary embodiments shown. An imaginary hypotrochoid center of the hypotrochoid is preferably located on the longitudinal shaft axis 12. The recesses 18 can therefore be distributed evenly and symmetrically around the circumference of the shaft 10. The shaft 10 is designed in such a way that the corners of the hypotrochoid are located outside the shaft lateral surface 14 of the shaft 10, so that the corners are not directly depicted in the recess arc shape. However, the number of corners corresponds to the number of recesses 18 in the shaft 10. Accordingly, the exemplary embodiments shown in FIG. 1a to 7 are based on hypotrochoids with four corners.

In each of the exemplary embodiments shown in FIG. 1a to 7, the shaft lateral surface 14 has a spindle toothing with four spindle teeth 32. The spindle teeth 32 extend helically around the circumference of the shaft 10 along the longitudinal shaft axis 12.

In particular, the views in FIGS. 1b and 2c illustrate that each of the axial recess walls 20 is formed at least in portions by a cut surface 34 of one of the spindle teeth 32. Each of the spindle teeth thus ends in one of the axial recess walls 20. The number of recesses 18 therefore corresponds to the number of spindle teeth 34.

The wall ends 36, 38 are preferably formed at the points at which the relevant radial recess wall 22 emerges from the shaft 10 along the recess arc shape. In the exemplary embodiments shown in FIG. 1a to 2c, the cut surface 34 of the spindle tooth 32 is located at a distance from the first wall end 36 and in the region of the second wall end 38. The exemplary embodiments shown in FIG. 1a to 2c are thus optimized for a first application, in which the torque transmission substantially only takes place in a first direction of rotation 40 and thus mainly in the region of the first wall end 36.

The exemplary embodiment of the shaft 10 shown in FIG. 3, on the other hand, is optimized for a second application, in which the torque transmission substantially takes place mainly in the region of the second wall end 38. This can be the case, for example, if torque is transmitted substantially in a second direction of rotation 42. The cut surfaces 34 of the spindle teeth 32 are each located at a distance from the corresponding second wall end 38 and in the region of the corresponding first wall end 36.

In a third application, for which the exemplary embodiment of the shaft 10 shown in FIG. 4 is provided, the torque transmission can take place in both directions of rotation and thus mainly in the region of the first wall end 36 and the second wall end 38. The cut surfaces 34 of the spindle teeth are accordingly located at a distance from the corresponding first wall end 36 and from the corresponding second wall end 38 and thus located centrally between the corresponding first wall end 36 and the corresponding second wall end 38.

On account of the described locations of the cut surfaces 34 in the different exemplary embodiments, the mechanical stress on the shaft 10 can be distributed as evenly as possible in the region of the recesses 18.

As can be clearly seen in particular in FIGS. 1a and 2b, a rim 44 is provided between the axial recess walls 20 and the shaft end 16. The shaft 10 has a central bore 46 along the longitudinal shaft axis 12. The rim 44 is formed by an additional shoulder in the shaft lateral surface 14, so that the rim 44 is circular and uninterrupted. The shaft end 16 is formed by a free end face of the rim 44. The exemplary embodiment shown in FIG. 2a to 2c differs from the exemplary embodiment shown in FIG. 1a to 1b in that the rim 44 can be cut by the recesses 18.

FIG. 5a to 5c show a first exemplary embodiment of a hub 48. The hub 48 comprises a longitudinal hub axis 50, a hub opening 52 extending along the longitudinal hub axis 50, and an inner wall 54 radially delimiting the hub opening 52. The inner wall has four hub arcuate portions 56 each with a constant hub arc radius 58, such that each of the hub arcuate portions 56 has a convex hub arc shape facing the longitudinal hub axis 50. Due to the convex hub arc shape facing the longitudinal hub axis 50, each of the hub arcuate portions 56 is bulbous when viewed from the longitudinal hub axis 50. The hub opening 52 is completely enclosed in a plane orthogonal to the longitudinal hub axis 50. The hub 48 is planar.

Each of the hub arcuate portions 56 has a first hub arc end 60 and a second hub arc end 62, each of the hub arc ends 60, 62 adjoining an undercut 64, each of the undercuts 64 being formed by an undercut bore. The different hub bore ends 60, 62 of the hub arcuate portions 56, which follow one another in the peripheral direction around the longitudinal hub axis 50, each adjoin the same undercut 64. The undercuts 64 are each oriented concavely toward the longitudinal hub axis 12. An undercut radius 65 of each of the undercuts 64 is preferably significantly smaller than the corresponding hub arc radius 58.

The hub arcuate portions 56 of the exemplary embodiments shown in FIG. 5a to 7 are arranged uniformly in a peripheral direction of the hub opening 52 around the longitudinal hub axis 50 and are designed in the same way. This results in the shape of a square with undercuts 65 at each of the corners.

As can be seen in particular from FIG. 5b, each of the hub arcuate portions 56 has, at the first hub arc end 60, a tangentially continuous transition 66 to the undercut 64 adjacent to the first hub arc end 60 in question.

According to the applications described above with regard to the shaft 10, the hub 48 can be adapted to different applications by selecting which of the hub arc ends 60, 62 has a tangentially continuous transition 66 to the correspondingly adjacent undercut 64. The exemplary embodiment of the hub 48 shown in FIG. 5a to 5c is thus optimized for a first application, in which the torque transmission substantially only takes place in a first direction of rotation 40 and thus mainly in the region of the first hub arc ends 60.

FIG. 6 shows an exemplary embodiment of the hub 48 provided for a second application, in which the torque transmission substantially only takes place in a second direction of rotation 42 and thus mainly in the region of the second hub arc ends 62. Each of the second hub arc ends 62 has a tangentially continuous transition 66 to the correspondingly adjacent undercut 64.

The exemplary embodiment of the hub 10 shown in FIG. 7 is designed for a third application, in which the torque transmission takes place in both directions of rotation 40, 42 and thus mainly in the region of the first hub arc ends 60 and the second hub arc ends 62. The undercut radius 65 is selected to be smaller and the undercuts 64 are located further away from the longitudinal hub axis 50 than in the exemplary embodiments shown in FIG. 5a to 6.

FIG. 8a to 8i show a shaft-hub connection 68 comprising the shaft 10 shown in FIG. 2a to 2b and the hub 48 shown in FIG. 5a to 5c. As can also be seen from FIGS. 2a and 2b and FIG. 5a to 5c, the hub 48 has the same number of hub arcuate portions 56 as the shaft 10 has recesses 18. The hub 48 is arranged on the shaft 10 in such a way that each of the hub arcuate portions 56 is arranged in exactly one of the recesses 18. As can be seen in particular from FIG. 8f, the inner wall 54 of the hub opening 52 is located in the region of the hub arcuate portions 56 so as to face the radial recess wall 22 of the relevant recess 18. In addition, a first side surface 70 of the hub 48 is in operative connection with the axial recess walls 20 of the recesses 18, in that the first side surface 70 directly abuts the axial recess walls 20 (see in particular FIG. 8e).

The hub 48 is arranged on the shaft 10 in such a way that the longitudinal hub axis 50 is aligned along the longitudinal shaft axis 12 and is located on the longitudinal shaft axis 12.

In addition to the first side surface 70, the hub has a second side surface 72 which is opposite the first side surface 70 and is clearly visible in FIG. 8a. The side surfaces 70, 72 adjoin the inner wall 54 of the hub 48 at an end face are oriented orthogonally to the longitudinal hub axis 50. The edge between the inner wall 54 and the first side surface 70 has a hub-side transition radius 74 (see also FIGS. 5a and 5c) which corresponds to the shaft-side transition radius 24.

The shaft 10 has, in each of the regions of the first hub arc ends 60 and in each of the regions of the second hub arc ends 62, an oversize 76 relative to the hub 48; this can be seen by viewing FIGS. 8d, 8h and 8i in combination. In the central regions of the hub arcuate portions 56 there is backlash 78 between the respective first hub arc ends 60 and the respective second hub arc ends 62. This is particularly evident when FIGS. 8d, 8e and 8f are viewed in combination. This allows a zero-backlash connection between the hub 48 and the shaft 10 to be achieved, and at the same time the required assembly force can be kept low.

As FIG. 8a shows, the shaft-hub connection 68 is designed in such a way that the rim 44 of the shaft 10 is reshaped radially outwards and axially in the direction of the hub 48, and the second side surface 72 of the hub is in operative connection with the reshaped rim 44 so as to axially secure the hub 48 on the shaft 10. In this way the reshaped rim 44 rests directly on the second side surface 72.

The shaft-hub connection 68 can be produced by first providing the shaft 10 and the hub 48 and arranging the hub 48 on the shaft 10 as described above. In this state, in which no deformation of the rim 44 has yet taken place, the shaft-hub connection is shown in FIG. 8c to 8i. Subsequently, the rim 44, which projects axially beyond the hub 48, is reshaped radially outwards and axially in the direction of the hub 48, in particular is flanged, for example by a tumbling method or a roller burnishing method. As soon as the rim 44 comes to rest on the second side surface 72, the reshaping is preferably terminated in order not to impair the strength of the reshaped rim 44. The state in which the rim rests on the second side surface 72 is shown in FIG. 8a.

### LIST OF REFERENCE NUMERALS

10 Shaft
12 Longitudinal shaft axis
14 Shaft lateral surface
16 Shaft end
18 Recess
Axial recess wall
22 Radial recess wall
24 Shaft-side transition radius
28 Recess radius
32 Spindle tooth
34 Cut surface
36 First wall end
38 Second wall end
First direction of rotation
42 Second direction of rotation
44 Rim
46 Central bore
48 Hub
50 Longitudinal hub axis
52 Hub opening
54 Inner wall
56 Hub arcuate portion
58 Hub arc radius
60 First hub arc end
62 Second hub arc end
64 Undercut
65 Undercut radius
66 Tangentially continuous transition
68 Shaft-hub connection
70 First side surface
72 Second side surface
74 Hub-side transition radius
76 Oversize
78 Backlash

1. A shaft (10), for transmitting a torque and/or an axial force, having a longitudinal shaft axis (12), a shaft lateral surface (14), and a shaft end (16), the shaft lateral surface (14) having at least one recess (18) with an axial recess wall (20) and a radial recess wall (22) adjacent to the axial recess wall (20), the radial recess wall (22) having a first wall end (36) and a second wall end (38), and the at least one recess (18) being open axially in the direction of the shaft end (16), characterized in that the radial recess wall (22) has a recess radius (28), such that the radial recess wall (22) has, at least in portions, a concave recess arc shape facing away from the longitudinal shaft axis (12).

2. The shaft according to claim 1, characterized in that the recess arc shape of the radial recess wall (22) extends from the first wall end (36) to the second wall end (38) and/or the recess radius (28) is variable.

3. The shaft according to claim 1, characterized in that the recess arc shape of the radial recess wall (22) corresponds to at least a portion of a hypotrochoid.

4. The shaft according to claim 3, characterized in that a hypotrochoid center of the hypotrochoid is located on the longitudinal shaft axis (12).

5. The shaft according to claim 1, characterized in that the shaft lateral surface (14) has a spindle toothing with at least one spindle tooth (32).

6. The shaft according to claim 5, characterized in that the axial recess wall (20) of at least one of the at least one recess (18) is formed at least in portions by a cut surface (34) of the at least one spindle tooth (32).

7. The shaft according to claim 6, characterized in that the cut surface (34) of the at least one spindle tooth (32) is located at a distance from the first wall end (36) and/or the second wall end (38) of the radial recess wall (22).

8. The shaft according to claim 6, characterized in that the at least one recess (18) comprises a plurality of recesses (18) and the at least one spindle tooth (32) comprises a plurality of spindle teeth (32), the number of recesses (18) corresponding to the number of spindle teeth (32), and the axial recess wall (20) of each of the recesses (18) being formed at least in portions by the cut surface (34) of one of the spindle teeth (32).

9. The shaft according to claim 1, characterized in that a rim (44) is provided between the axial recess wall (20) and the shaft end (16).

10. A hub (48) having a longitudinal hub axis (50), a hub opening (52) extending along the longitudinal hub axis (50), and an inner wall (54) radially delimiting the hub opening (52), characterized in that the inner wall (54) has at least one hub arcuate portion (56) with a hub arc radius (58), such that the at least one hub arcuate portion (56) has a convex hub arc shape facing the longitudinal hub axis (50).

11. The hub according to claim 10, characterized in that the hub arc radius (58) is constant.

12. The hub according to claim 10, characterized in that the at least one hub arcuate portion (56) has a first hub arc end (60) and a second hub arc end (62), each of the hub arc ends (60, 62) adjoining an undercut (64).

13. The hub according to claim 12, characterized in that the at least one hub arcuate portion (56) has, at the first hub arc end (60), a tangentially continuous transition (66) to the undercut (64) adjoining the first hub arc end (60) and/or has, at the second hub arc end (62), a tangentially continuous transition (66) to the undercut (64) adjoining the second hub arc end (62).

14. The hub according to claim 10, characterized in that the at least one hub arcuate portion (56) comprises a plurality of hub arcuate portions (56) which are located uniformly in a peripheral direction of the hub opening (52) around the longitudinal hub axis (50).

15. A shaft-hub connection (68) having a shaft (10) according claim 1, and the hub (48) being arranged on the shaft (10) in such a way that
the at least one hub arcuate portion (56) is arranged in the at least one recess (18),
the inner wall (54) of the hub opening (52) is located in the region of the at least one hub arcuate portion (56) so as to face the radial recess wall (22) of the at least one recess (18), and
a first side surface (70) of the hub (48) is in operative connection with the axial recess wall (20) in the at least one recess (18).

16. The shaft-hub connection according to claim 15, characterized in that the at least one hub arcuate portion (56) corresponds in number and arrangement to the at least one recess (18).

17. The shaft-hub connection according to claim 15, characterized in that the shaft (10) has, in the region of the first hub arc end (60) and in the region of the second hub arc end (62) of the at least one recess (18), an oversize (76) relative to the hub (48) and in that the shaft (10) has, in a central region of the at least one hub arcuate portion (56), between the first hub arc end (60) and the second hub arc end (62), backlash (78) relative to the hub (48).

18. The shaft-hub connection according to claim 15, having a shaft characterized in that the rim (44) of the shaft (10) is reshaped radially outward and axially in the direction of the hub (48), so that a second side surface (72) of the hub (48), located opposite the first side surface (70), is in operative connection with the reshaped rim (44).

19. An electric actuator having a shaft-hub connection (68) according to claim 15.
